(19) United States
(12) Patent Application Publication
(10) Pub. No.: US 2020/0132146 A1
(43) Pub. Date: Apr. 30, 2020

(54) Brake disc with (Longitudinal Vortex Generator)

(71) Applicant: Lawrence Zhang, Montreal (CA)

(72) Inventor: Lawrence Zhang, Montreal (CA)

(21) Appl. No.: 16/350,289

(22) Filed: Oct. 26, 2018

(51) Int. Cl. F16D 65/12; F16D 65/847

(52) U.S. Cl. CPC F16D 65/128; F16D 2065/1328; F16D 65/124; F16D 65/847

(57) ABSTRACT

A ventilated brake disc comprising a pair of annular members, each having a brake application surface and a back surface, a plurality of connection members that connects said pair of annular members and defines, together with said back surface, ventilation channels for passage of cooling air, and a plurality of longitudinal vortex generators (LVG) disposed along the passage of cooling air that generates vortices with a central axis in the downstream direction of the cooling air.

### FIELD OF THE INVENTION

The present invention relates mainly to a ventilated brake disc for road vehicles and railway vehicles.

### BACKGROUND OF THE INVENTION

Disc brake units with ventilated brake discs are employed widely to slow down and/or stop road and railway vehicles. During braking application, ventilated brake disc transforms kinetic energy into heat by means of friction between the disc and pads. When a brake disc is heated due to braking, it should be cooled down as fast as possible to keep brake disc operating at relatively low temperatures and to avoid overheating related brake disc failures.

Convective air cooling contributes to the majority of the heat dissipated from a ventilated brake disc. The ventilation channels configured in between two annular members of the ventilated brake disc works as a centrifugal impeller. The cooling air flow is pumped into the central circular inlet and then pushed through the ventilation channels. The fresh air flow is sucked into the inlet by the locally lower pressure.

The efficiency of convective air cooling provided by those ventilation channels, measured by dissipated heat flux, depends on contact surface area of the cooling air and the brake disc, mass flow rate of the cooling air passing through the ventilation channels, and convective heat transfer coefficient between the passing cooling air and the brake disc surfaces.

From U.S. Pat. No. 10,024,377B2, U.S. Pat. No. 9,791,007B2 and U.S. Pat. No. 9,587,690B2, efficient cooling of a ventilated brake disc remains a constant challenge and improved air cooling built in the ventilated brake disc can improve the performance and prolong the service life of the ventilated brake disc by reducing brake disc operating temperatures.

The traditional techniques of achieving lower brake disc operating temperatures include:
(1) adding more vanes mainly to achieve larger heat transfer area and meanwhile resulting in heavier mass which help slow down the temperature rise in the ventilated brake disc;
(2) increasing surface roughness and adding more crests or pillars to the brake disc which also achieve larger heat transfer area and result in heavier mass, plus raising surface heat transfer coefficient mainly by introducing turbulences or transverse vortices.

However, heavier mass of brake disc increases the sprung mass of the vehicle, not desirable for the performance of the vehicle. Introduction of turbulence and transverse vortices in cooling air flow comes with pressure loss or drag along the air flow passage in the ventilation channels which limits the flow rate of the cooling air passing through the ventilated disc, limiting the amount of heat dissipated from the disc.

### SUMMARY OF THE INVENTION

The purpose of the present invention is to provide a brake disc with improved heat dissipation capacity that allows the brake disc operating at reduced temperatures, without adding significant mass to the brake disc.

To attain the above-mentioned object, the present invention is characterized by equipping brake disc with longitudinal vortex generator (LVG) that generates longitudinal vortices along the cooling air passage through the ventilation channels of the brake disc.

### BRIEF DESCRIPTION OF THE DRAWINGS

Other uses and advantages of the present invention will become apparent to those skilled in the art upon reference to the specification and the drawings, in which:

FIG. 1 is a partial cross-sectional view of a ventilated brake disc with configured ventilation channels formed by vanes to which a method of mounting a longitudinal vortex generator by casting according to an embodiment of the present invention is provided;

FIG. 1A is a partial sideview of the ventilated brake disc shown in FIG. 1;

FIG. 2 is a partial cross-sectional view of a ventilated brake disc with ventilation channels configured in form of pillars to which a method of mounting a longitudinal vortex generator by casting according to an embodiment of the present invention is provided;

FIG. 2A is a partial sideview of the ventilated brake disc shown in FIG. 2;

FIG. 3 is a partial sideview of a ventilated brake disc with ventilation channels formed by vanes to which a method of mounting a plurality of longitudinal vortex generators on a die-formed insert according to an embodiment of the present invention is provided;

FIG. 3A is a schematic view of the die-formed insert shown in FIG. 3 in which a plurality of longitudinal vortex generating devices are created in the insert;

FIG. 4A is a schematic view of a longitudinal vortex generating device in form of triangular rib made by casting.

FIG. 4B is a schematic view of a longitudinal vortex generating device in form of triangular rib made by forming;

FIG. 4C is a schematic view of a longitudinal vortex generating device in form of rectangular fin made by casting;

FIG. 4D is a schematic view of a longitudinal vortex generating device in form of rectangular fin made by forming.

### DESCRIPTION OF THE PREFERRED EMBODIMENTS

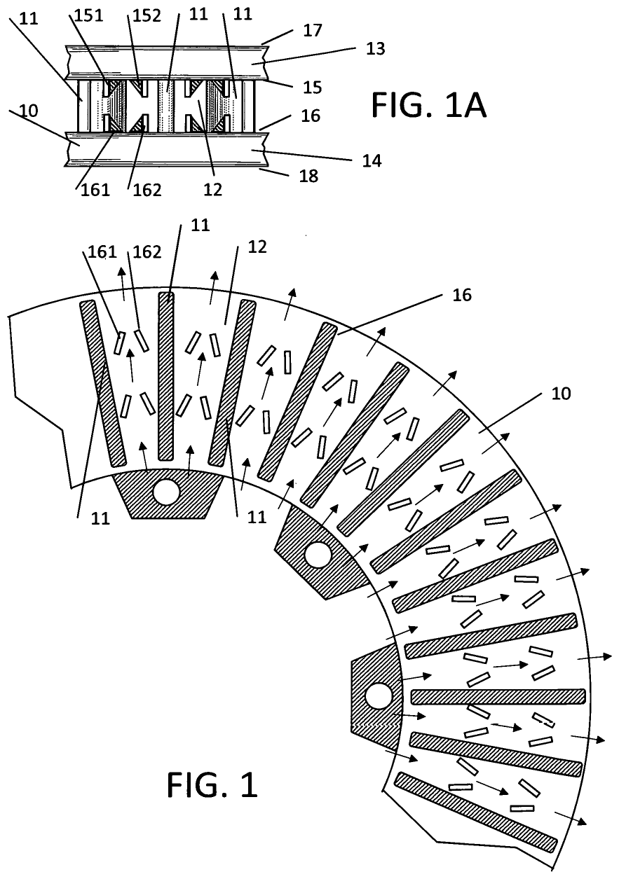

FIG. 1 and FIG. 1A display one embodiment of the present invention. A brake disc 10 has two annular members 13 and 14, the annular member 13 having a braking application surface 17 and back surface 15, the annular member 14 having a braking application surface 18 and back surface 16. The brake disc 1U has also a plurality of vanes 11 which connect said two annular members 13 and 14, dividing the space between the two annular members into a plurality of ventilation channel 12.

A plurality of longitudinal vortex generators (LVG) 151, 152, 161 and 162 are disposed in the ventilation channel 12. In details, a plurality of pairs of longitudinal fins configured in the form of triangular rib 151, 152 are disposed on the back surface 15, while a plurality of pairs of triangular rib 161 and 162 are disposed on the back surface 16. Equal number of pair of 151 and 152, as well as pair of 161 and 162 are uniformly distributed in all ventilation channels 12 across the disc 10.

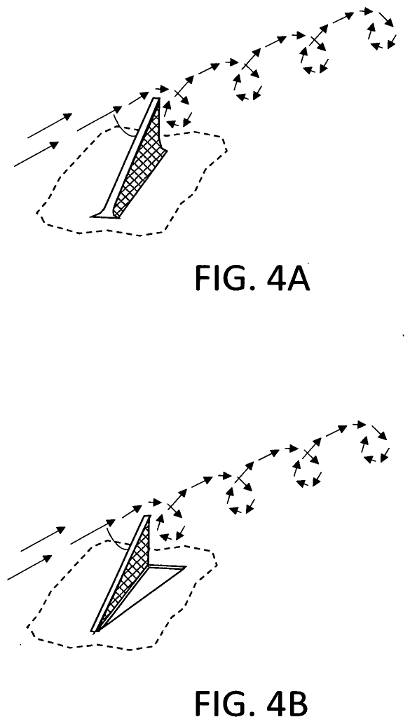

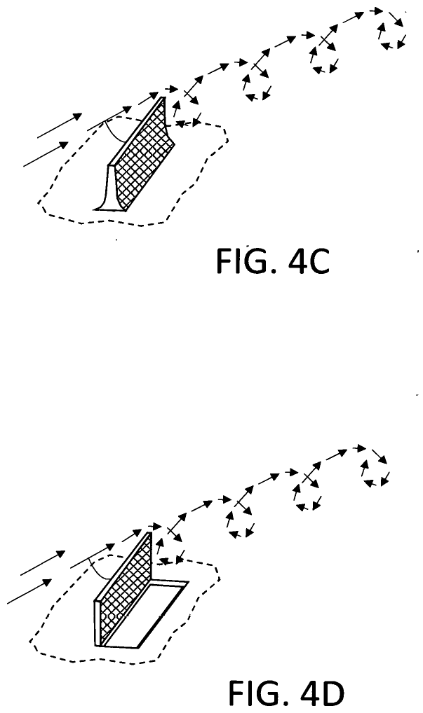

As illustrated in FIG. 4A, a typical lightweight triangular rib, such as triangular rib 151, 152, 161 and 162 are all arranged at elevation angles with respect to the downstream direction of the cooling air flow on a vertical plane generally perpendicular to the back surface of 15 and 16. Meanwhile, all triangular ribs, 151, 152, 161 and 162 take acute angles with downstream direction on a horizontal plane generally parallel to the back surface of 15 and 16. The downstream direction of the cooling air in this case is generally aligned with radial direction of the disc 10.

The brake disc 10 and LVG 151, 152, 161 and 162 are made of vermicular graphite cast iron or spheroidal graphite cast iron. Other suitable material such as alloy steel, aluminum alloy, or carbon-ceramic etc., may be used as well, but vermicular and spheroidal graphite cast iron's characteristics make them ideally suited for this application.

During vehicle braking, the heat generated from the brake application surface 17 and 18 is absorbed by the mass of the annular member 13 and 14, and transferred to the back surface 15 and 16, as well as the surface of the vane 11, and then is dissipated to surrounding air by convective heat transfer. Acting as a centrifugal impeller, the rotating brake disc 10 forces cooling air flowing within the ventilation channels 12.

As the cooling air passes each LVG, longitudinal vortices are generated and travel along the ventilation channels 12. Different from increasing surface roughness or adding pillars or crests in the prior art that generate mainly turbulences and transverse vortices, LVG 151, 152, 161 and 162, generate longitudinal vortices with axes parallel to the downstream direction of the passage of cooling air.

Longitudinal vortex enhances convective heat transfer in the following way: reducing boundary layer thickness, flow destabilization, and growing the temperature gradient near the heat transfer surface.

From microscale, as air passes LVGs, strong secondary swirling flow is generated, and the tangential velocity of the vortices can be higher than the main flow velocity. The high-velocity swirling secondary flow can not only promote mixing of the cooling air in the ventilation channel 12, but also inject the high-energy flow into the boundary layer established between the cooling air and the surface of the ventilation channel 12, to suppress and delay the boundary layer separation, which decrease profile drag.

As a result, LVG 151, 152, 161 and 162 promotes substantially convective heat transfer between the brake disc 10 and passing air, accelerating the heat dissipation from the brake disc 10 and reducing the operating temperatures on the brake application surface 17 and 18, while introducing only mild drag and adding limited mass to the brake disc 10. The only mild additional drag assures supply of fresh air flowing through the ventilation channel 12 necessary to cool the brake disc 10.

The introduction of LVG or replacement of certain number of crests or pillars in prior arts by LVG, optimize the cooling air flow along its passage through the ventilation channel 12 of the brake disc 10 and improve the performance of said disc 10.

The pair of triangular ribs 151 and 152, as well as the pair of triangular ribs 161 and 162, allow the generated vortices to have mutually opposite rotational directions to carry out efficient cooling to the brake disc 10 and also suppress the pressure loss or drag along the passage of cooling air through the ventilation channel 12.

It should be noted that other embodiments different from the one shown in FIG. 1 and FIG. 1A are possible, for example,
(a) only one or other number of longitudinal vortex generators instead of exactly two pairs may be disposed in each ventilation channel 12, for particular disc design;
(b) Longitudinal fin can take other profile such as rectangular shown in FIG. 4C or airfoil cross section.

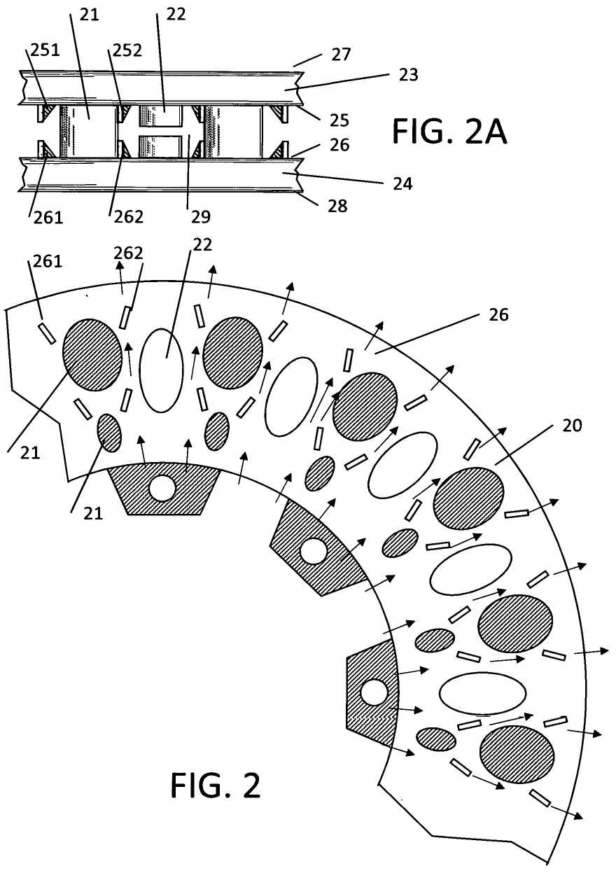

FIG. 2 and FIG. 2A display an alternative embodiment of the present invention. A brake disc 20 has two annular members 23 and 24, the annular member 23 having a braking application surface 27 and back surface 25, the annular member 24 having a braking application surface 28 and back surface 26. The brake disc 20 has also a plurality of pillars 21, large or small, that connect said two annular members 23 and 24; as well as a plurality of crests 22, protruding from the back face 25 and 26. Together with back surface 25 and 26, the pillars 21 forms a plurality of ventilation channels 29.

A plurality of longitudinal vortex generators (LVG) 251, 252, 261 and 262 are disposed on the back surface 25 and 26. Equal number of 251, 252, 261 and 262 are uniformly distributed around the disc 20. In details, a plurality of longitudinal fins configured in the form of triangular rib 251 and 252 are disposed on the back surface 25, while a plurality of triangular rib 261 and 262 are disposed on the back surface 26.

As illustrated in FIG. 4A, a typical lightweight triangular rib, such as triangular rib 251, 252, 261 and 262 are all arranged at elevation angles with respect to the downstream direction of the cooling air flow on a vertical plane generally perpendicular to the back surface of 25 and 26. Meanwhile, all triangular ribs, 251, 252, 261 and 262 take acute angles with downstream direction on a horizontal plane generally parallel to the back surface of 25 and 26.

The brake disc 20 and LVG 251, 252, 261 and 262 are made of vermicular graphite cast iron or spheroidal graphite cast iron. Other suitable material such as alloy steel, aluminum alloy, or carbon-ceramic etc., may be used as well, but vermicular and spheroidal graphite cast iron's characteristics make them ideally suited for this application.

The functional mechanism of the embodiment presented in FIG. 2 and FIG. 2A, as well as their benefits are identical to the previous one presented in FIG. 1 and FIG. 1A.

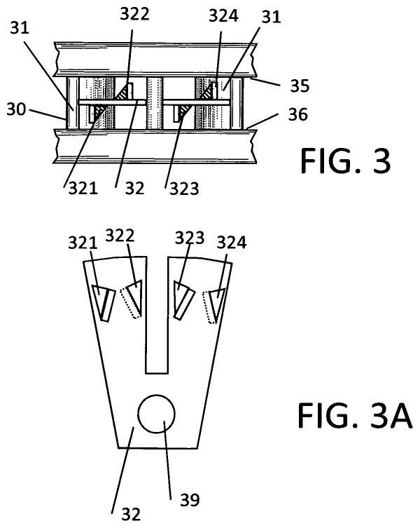

FIG. 3 and FIG. 3A display another alternative embodiment of the present invention. A brake disc 30 has similar arrangement of vanes 31 as the vane 11 in FIG. 1 and FIG. 1A.

A plurality of plate 32 to which vortex generators are mounted is provided. In details, triangular rib 321, 322, 323 and 324 are die-formed from the plate 32.

As illustrated in FIG. 4B, a typical die-formed lightweight triangular rib, such as triangular rib 321, 322, 323 and 324 are all arranged at elevation angles with respect to the downstream direction of the cooling air flow on a vertical plane generally perpendicular to the back surface of 35 and 36. Meanwhile, all triangular ribs, 321, 322, 323 and 324 take acute angles with downstream direction on a horizontal plane generally parallel to the back surface of 35 and 36.

The plate 32 is mounted to the brake disc 30 with the aid of the hole 39.

The plate 32 and LVG 321, 322, 323, 324 are made of T-5054 grade aluminum alloy. Other suitable material may be used as well, but aluminum's characteristics make it ideally suited for this application.

It should be noted that other embodiments different from the one shown in FIG. 3 and FIG. 3A are possible, for example, in the case of a mechanically mounted brake disc comprising two individual annular members plus one insert sandwiched between said two individual annular members, LVG can be built on or mounted to said insert by suitable casting, forging forming or joining process.

FIG. 4A, and FIG. 4B demonstrate details of two possible embodiments of the present invention: triangular-shaped longitudinal fins (ribs) created either by casting or by forming.

FIG. 4C and FIG. 4D demonstrate details of another two possible embodiments of the present invention: rectangular-shaped longitudinal fins created either by casting or by forming.

It should be noted that the profile and cross section of the longitudinal fins (ribs) can take any other suitable shape depending on particular application and particular manufacturing method. The longitudinal fins (ribs) may also be built on the surface of said vanes 11 in FIG. 1, said pillars 21 or crests 22 in FIG. 2, instead of the back surface 15, 16 in FIG. 1 and the back surface 25 and 26 in FIG. 2.

The above embodiments of the present invention are presented using monobloc axle mounted brake disc in which the pair of annular members, as well as the vanes, pillars or crests, built in the back of the two annular members are made by casting. It should be noted that the present invention is also applicable to segmented-ring type of axle mounted brake disc, as well as monobloc-ring type of wheel mounted brake disc, or segmented-ring type wheel mounted brake disc. Those wheel mounted brake discs, in pair, are mounted to the wheel blank from both sides by a plurality of fasteners.

The present invention has been described in connection with the preferred embodiments of the various figures. It is to be understood that other similar embodiments may be used, or modifications and additions may be made to the described embodiment for performing the same function of the present invention without deviating therefrom. Therefore, the present invention should not be limited to any single embodiment, but rather construed in breadth and scope in accordance with the recitation of the appended claims.

What is claimed is:

1. A disc for a disc brake, comprising
(a) a pair of annular members arranged coaxially with respect to each other, each annular member having extending from one side thereof an annular braking application surface for braking engagement by a braking means and a back surface opposite to said braking application surface;
(b) a plurality of connection elements connecting said pair of annular members and defining ventilation channels for passage of a flow of cooling air;
(c) a vortex generating device disposed along said passage of the flow of cooling air, generating longitudinal vortices that has a central axis in the downstream direction.

2. The disc according to claim 1, the connection elements are generally radially extending vanes that define, together with said back surfaces, ventilation channels generally projecting from inner perimeters to outer perimeters of said pair of annular members.

3. The disc according to claim 1, the connection elements are generally pillars having a radial extent less than the difference between inner radius and outer radius of said annular member.

4. The disc according to claim 1, wherein said vortex generating device is a longitudinal fin with thickness to height ratio generally less than 0.4.

5. The disc according to claim 4, wherein the longitudinal fin is a plurality of triangular ribs that have an elevation angle with respect to the downstream direction of the cooling air.

6. The disc according to claim 4, wherein the longitudinal fin takes an acute angle of less than 85 degrees relative to primary flow direction of the cooling air.

7. The disc according to claim 4, wherein the longitudinal fin is made by casting out of the same material as said annular member.

8. The disc according to claim 2, wherein the plurality of vortex generating devices are arranged in a paired manner on said back surface, so that they generate vortices having rotational directions opposed to each other.

9. The disc according to claim 1, wherein the vortex generating device is a longitudinal fin die-formed from a sheet of metal and said sheet of metal being disposed inside said ventilation channels.
